(19) United States
(12) Patent Application Publication
(10) Pub. No.: US 2013/0066881 A1
(43) Pub. Date: Mar. 14, 2013

(54) INDEXING SYSTEM OF SPATIAL INFORMATION FOR COMBINED SOI OBJECT AND CONTENT

(71) Applicants: Cheol-Woo Park, Seoul (KR); Hong-Hoi Kim, Daejeon (KR)

(72) Inventors: Cheol-Woo Park, Seoul (KR); Hong-Hoi Kim, Daejeon (KR)

(73) Assignee: Hyundai Motor Company, Seoul (KR)

(21) Appl. No.: 13/615,037

(22) Filed: Sep. 13, 2012

Related U.S. Application Data
(63) Continuation-in-part of application No. 13/320,649, filed on Nov. 15, 2011.
(60) Provisional application No. 61/591,143, filed on Jan. 26, 2012.

(30) Foreign Application Priority Data
May 15, 2009 (KR) 10-2009-0042401

(51) Int. Cl. G06F 17/30

(52) U.S. Cl. 707/743; 707/E17.083

(57) ABSTRACT

One aspect of the invention provides an indexing system of space of interest (SOI) defining at least a two-dimensional object. The system includes: a location data extractor configured calculate an index point for the space of interest; a map tile number converter configured to map the index point to a tile that lies within a plurality of tiles; and an indexer configured to index the space of interest based on the determined tile.

### CROSS-REFERENCE TO RELATED APPLICATIONS

This application claims priority under 35 U.S.C. §119(e) to U.S. Provisional Patent Application Ser. No. 61/591,143, filed Jan. 26, 2012. This application is also a continuation-in-part under 35 U.S.C. §120 of U.S. patent application Ser. No. 13/320,649, filed Nov. 15, 2011, which is a national phase application under 35 U.S.C. §371 of International Application No. PCT/KR2010/003055, filed May 14, 2010, which claim priority to Korean Patent Application No. 10-2009-0042401, filed May 15, 2009. The entire content of each of the above-referenced patent applications is hereby incorporated by reference herein.

### TECHNICAL FIELD

The present disclosure relates to an indexing system that provides a rapid and effective retrieval method for a combined space of interest (SOI) object and content. Specifically, the present disclosure relates to an indexing system that provides a rapid retrieval of location information by using an inverted file database of index information which is a combination of location information and keyword contents. A space of interest (SOI) refers to a collection of data about a space of people's interest or use. An SOI is made up of point, line and/or plane and has a unique identifying data. An SOI object refers to a structure which binds spatial information, identifying data and property information (e.g., color, thickness of line, type of line, time of exposure, allowed time of use, control of permission to access) of an SOI.

### BACKGROUND

A keyword-based retrieval/indexing method is a commonly known retrieval method in which a keyword is analyzed in the form of natural language. In the method, keywords are extracted from a document for retrieval, and during the process the keywords and relevant document thereto are stored in an inverted file structure. When searching by using keywords, document contents associated with the given keywords are extracted from the inverted file structure, and then a search result is shown to a user with an assigned priority. The keyword-based retrieval/indexing method has been improved in the form of subject-based information retrieval in which a search result is shown in accordance with a relevance to a keyword of a subject.

There has not been much progress, however, in the method for searching location or area based information.

### SUMMARY OF THE INVENTION

The present disclosure has been made in an effort to provide an indexing system for an effective retrieval of combined SOI object and content. Further, the present disclosure provides an indexing system for a rapid and effective retrieval of location information by using a map tile number according to Tile Map Service (TMS).

One aspect of the invention provides an indexing system of space of interest (SOI) defining at least a two-dimensional object. The system includes: a location data extractor configured calculate an index point for the space of interest; a map tile number converter configured to map the index point to a tile that lies within a plurality of tiles; and an indexer configured to index the space of interest based on the determined tile.

In one embodiment, the SOI object is a combination of coordinates covering a certain boundary.

In another embodiment, the location data extractor is further configured calculate an index point for the space of interest by: creating a minimum bounding rectangle that encompasses the space of interest; determining a center of the minimum bounding rectangle; and returning the center of the minimum bounding rectangle as the index point for the space of interest. The minimum bounding rectangle can be defined by the minimum X coordinate (Xₘᵢₙ) of the space of interest, the minimum Y coordinate (Yₘᵢₙ) of the space of interest, the maximum X coordinate (Xₘₐₓ) of the space of interest, and the maximum Y coordinate (Yₘₐₓ) of the space of interest and the center of the minimum bounding rectangle can be defined as

$$( {X}_{min} + \frac{{X}_{max} - {X}_{min}}{2} , {Y}_{min} + \frac{{Y}_{max} - {Y}_{min}}{2} ) .$$

The location data extractor can be further configured calculate an index point for the space of interest by modifying the index point to reflect one or more selected from the group consisting of: popularity of local tiles and user activity in local tiles.

In another embodiment, the LBS indexer receives keyword index information to perform mapping thereof in addition to a plurality of SOI objects mapped onto corresponding map tile numbers.

Another aspect of the invention provides an indexing system of space of interest (SOI) object. The system includes: a location data extractor configured to identify an SOI object; a map tile number converter configured to perform a spatial operation between the SOI object and a map tile number, and to perform mapping of the SOI object onto a corresponding map tile number; and an LBS indexer configured to store a plurality of SOI objects mapped onto the corresponding map tile numbers in the form of an inverted file database.

In one embodiment, the SOI object is a combination of coordinates covering a certain boundary.

In another embodiment, the map tile converter performs mapping of the SOI object onto at least one or more of a plurality of map tile numbers, if the result of a spatial operation of the map tiles shows that the SOI objects cover a plurality of map tiles.

Another aspect of the invention provides a method for indexing a space of interest (SOI) defining at least a two-dimensional structure. The method includes: calculating an index point for the space of interest; determining which tile the index point lies within amongst of a plurality of tiles; and indexing the space of interest based on the determined tile.

In one embodiment, the calculating step includes: creating a minimum bounding rectangle that encompasses the space of interest; determining a center of the minimum bounding rectangle; and returning the center of the minimum bounding rectangle as the index point for the space of interest. In another embodiment, the minimum bounding rectangle is defined by the minimum X coordinate (Xₘᵢₙ) of the space of interest, the minimum Y coordinate (Yₘᵢₙ) of the space of interest, the maximum X coordinate (Xₘₐₓ) of the space of interest, and the maximum Y coordinate (Yₘₐₓ) of the space of interest and the center of the minimum bounding rectangle is

defined as

$$( {X}_{min} + \frac{{X}_{max} - {X}_{min}}{2} , {Y}_{min} + \frac{{Y}_{max} - {Y}_{min}}{2} ) .$$

In another embodiment, the location data extractor is further configured calculate an index point for the space of interest by modifying the index point to reflect one or more selected from the group consisting of: popularity of local tiles and user activity in local tiles.

Another aspect of the invention provides a computer program product for causing a computer to perform a method for indexing a space of interest (SOI) defining at least a two-dimensional structure. The computer program product includes computer-usable medium having control logic stored therein that, when executed by a processor, is operable to: calculate an index point for the space of interest; determine which tile the index point lies within amongst of a plurality of tiles; and index the space of interest based on the determined tile.

Another aspect of the invention provides a method of indexing a space of interest (SOI) object. The method includes: identifying an SOI object; performing a spatial operation between the SOI object and a map tile number; performing mapping of the SOI object onto a corresponding map tile number; and storing a plurality of SOI objects mapped onto the corresponding map tile numbers in the form of an inverted file database.

Another aspect of the invention provides a computer program product for causing a computer to perform a method of indexing a space of interest (SOI) object. The computer program product includes computer-usable medium having control logic stored therein that, when executed by a processor, is operable to: identify an SOI object; perform a spatial operation between the SOI object and a map tile number; perform mapping of the SOI object onto a corresponding map tile number; and store a plurality of SOI objects mapped onto the corresponding map tile numbers in the form of an inverted file database.

### BRIEF DESCRIPTION OF THE DRAWINGS

FIG. 1 is an exemplary diagram illustrating a geographic information retrieval system using POI information.

FIG. 2 is a block diagram schematically illustrating a configuration of an indexing system of SOI object according to the present disclosure.

FIG. 3 is an exemplary diagram illustrating a method for mapping of SOI onto map tile numbers when SOI object is spread over a plurality of map tile numbers.

FIG. 4 is an exemplary diagram illustrating a method of adding map tile number.

### DETAILED DESCRIPTION

The present disclosure will be described in detail with reference to the accompanying drawings, in which the same reference numerals will be used to refer to the same parts. If considered unnecessary for understanding the principles of the present disclosure, detailed descriptions of other portions of known components will be omitted so as not to obscure the invention.

Subject-based keyword retrieval/indexing method has been used for a retrieval system of geographic information such as point of interest (POI).

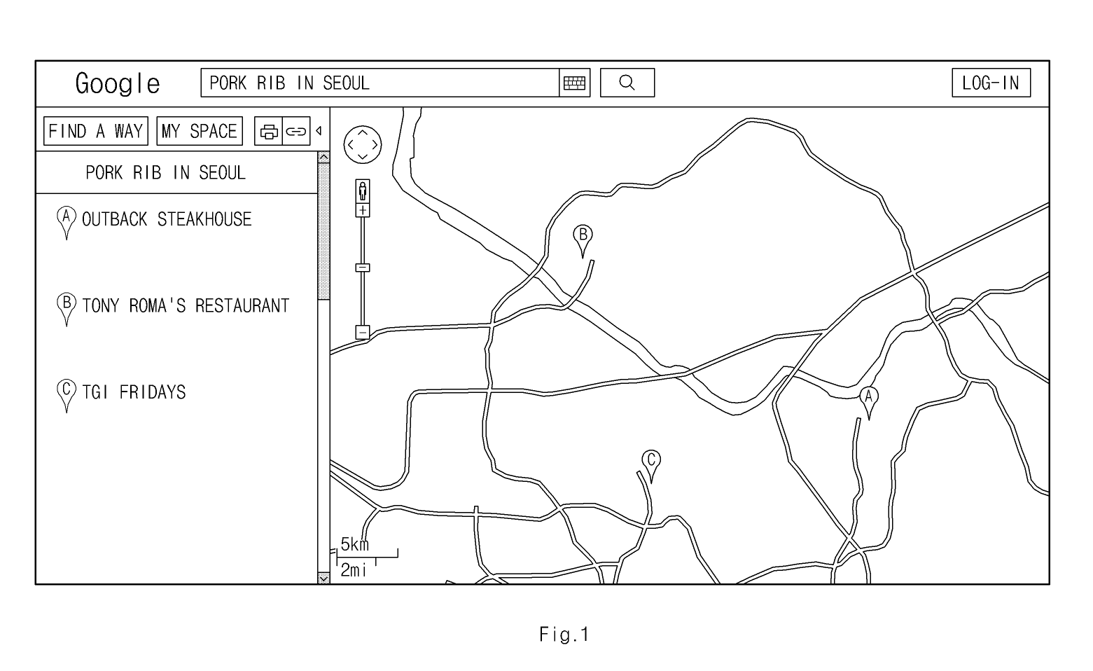

FIG. 1 is an exemplary diagram illustrating a geographic information retrieval system using POI information.

For example, when searching geographic information by using a word “pork rib in Seoul,” one keyword “Seoul” and the other keyword “pork rib” are retrieved respectively from the inverted file structure, and the overlapped POI information (here, information on restaurants) is then extracted from each result. Geographic information of X and Y positions of, for example, (A) Outback Steakhouse, (B) Tony Roma's Restaurant and (C) TGI Fridays, is extracted and displayed on a map (here, a map of surrounding areas of Seoul. The X, Y positions of extracted geographic information of all three A, B, and C are marked on the map.

However, geographic information retrieval system using POI basically adopts the keyword-based retrieval method, which merely displays on the map X, Y coordinate values obtained from the retrieval result of POI information.

Further, location-based data using POI information is based on a certain point displayed with X and Y coordinates values as a unit. In other words, when searching a certain location, location-based service using POI data only displays a relevant point according to a coordinate (for example, when searching a building, a coordinate of the entrance of the building is only displayed), such information as the size of the area or sub-facilities may not be shown exactly. Hence, the spatial concept of SOI has been introduced in an effort to provide an SOI-based geographic information service.

However, there are currently no effective methods for searching SOI object. That is, a keyword-based retrieval/indexing method does not provide effective search of SOI. In addition, geographic information retrieval service using POI is not suitable to be applied for an SOI as POI information is not based on a spatial concept.

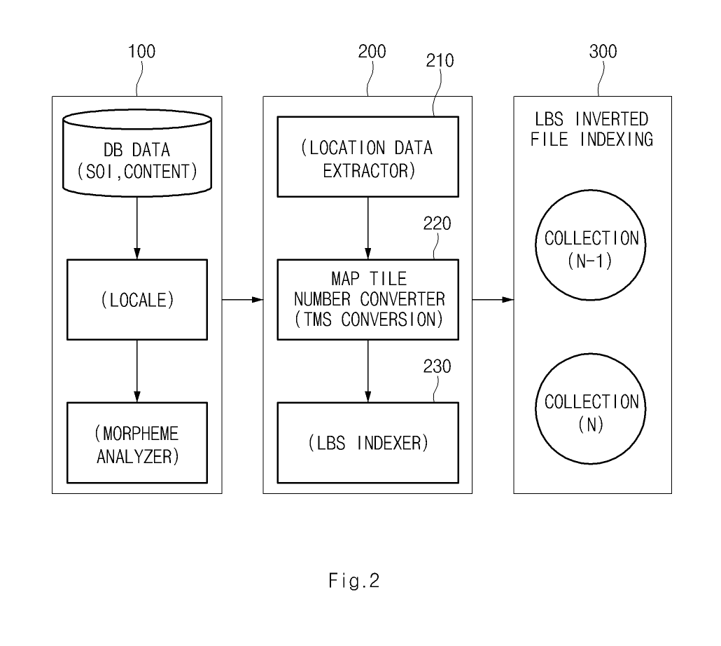

FIG. 2 is a block diagram schematically illustrating a configuration of an indexing system of SOI object according to the present disclosure.

The indexing system for retrieval of SOI object according to the present disclosure includes a keyword indexer 100, an LBS information indexer 200, and an LBS inverted file indexing module 300.

The keyword indexer 100 performs a process of extracting SOI object or content data stored in SOI database or content database, followed by a process of normalization through Locale.

Keyword index information is then extracted by analyzing morphemes through morpheme analyzer, and tagging parts of speech. The detailed description of the internal operation of the keyword indexer 100 will be omitted as it is performed in the same way as the conventional keyword search/index method.

The LBS information indexer 200 includes a location data extractor 210, a map tile number converter 220, and an LBS indexer 230.

The location data extractor 210 uses location information of SOI object to extract a Minimum Bounding Rectangle (MBR) and obtain a center point from the MBR thus extracted.

Location information of an SOI object covers a certain boundary within which information of X, Y position is displayed. The SOI information may be shown in the form of a simple rectangle, a curve, or an irregular form.

Information value of X, Y position within a certain boundary is extracted from the SOI object having such various forms to obtain an MBR.

Accordingly, an MBR may be defined with RECTANGLE (Xmin, Ymin, Xmax, Ymax) values.

The RECTANGLE (Xₘᵢₙ, Yₘᵢₙ, Xₘₐₓ, Yₘₐₓ) values obtained from an MBR are then used to obtain a center point (X, Y) that represents the relevant SOI object information. Here, the center point (X, Y) may be obtained from arithmetic mean calculated with an arithmetic

expression of

$$( {X}_{min} + \frac{{X}_{max} - {X}_{min}}{2} , {Y}_{min} + \frac{{Y}_{max} - {Y}_{min}}{2} ) .$$

According to a preferred embodiment of the present disclosure, an index point of the space of interest can be modified to reflect one or more factors such as the popularity of local tiles and/or user activity in local tiles. Such modifications increase the likelihood that an SOI spanning multiple tiles will be indexed within a tile that is popular and/or well-reviewed by other users. Such a modified index point can be referred to a weighted index point (WIP).

In one embodiment, a weighted index point can be calculated according to the expression

$$WIP = ( {X}_{min} + ( 1 + {S}_{x} W ) \frac{{X}_{max} - {X}_{min}}{2} , {Y}_{min} + ( 1 + {S}_{y} W ) \frac{{Y}_{max} - {Y}_{min}}{2} ) ,$$

wherein Sₓ equals the sign (i.e., 1 or −1) of the x coordinate of the W tile minus the x coordinate of the SOI's arithmetic mean and S_{y} equals the sign (i.e., 1 or −1) of the y coordinate of the W tile minus the y coordinate of the SOI's arithmetic mean. The weighted tile W is the maximum of (Wₚ₁+αWₐ₁, . . . , Wₚₙ+αWₐₙ) 0<W<1. Wₚ represents the total weight of the SOI's popularity within a tile (e.g., as measured by the number of reads of the SOI or the number of references to the SOI). Wₐ represents the total weight of user activity (e.g., reviewing SOIs, suggesting SOIs, sharing SOIs, and the like) within a tile. α is a weight value that can be arbitrarily set by an administrator to balance the influence of an user activity Wₐ relative to an SOI's popularity Wₚ.

According to another preferred embodiment of the present disclosure, if SOI object covers a wide range of areas or buildings such that it spreads over multiple boundaries or a plurality of tile map numbers, a multitude of center points (X, Y) may be obtained for the SOI object.

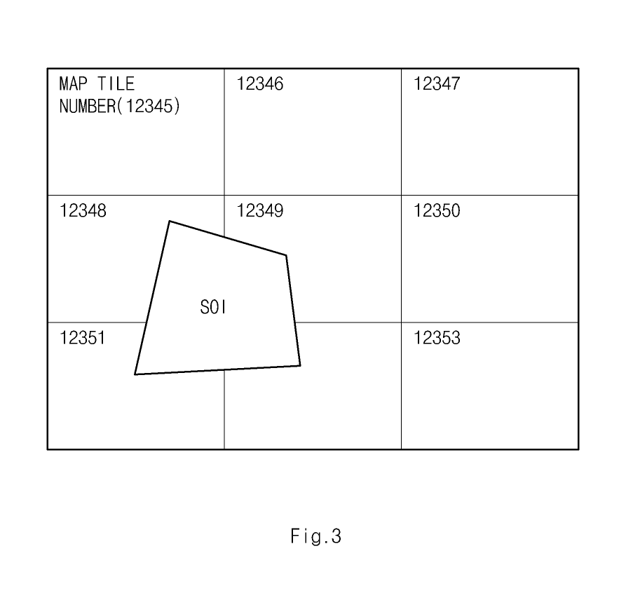

As shown in FIG. 3, SOI object covers four map tile numbers of 12348, 12349, 12351 and 12352. To determine whether a map tile number covers SOI object, a spatial operation is performed with respect to the SOI object and the map tile number. In such case as FIG. 3, where map tile numbers of 12348, 12349, 12351 and 12352 cover SOI object, it is desired that the SOI object is mapped onto all of the map tile numbers that cover the SOI object.

According to a preferred embodiment of the present disclosure, the process of obtaining a center point of SOI object is omitted, and it is possible to determine only whether a map tile number covers the SOI object by performing a spatial operation with respect to the SOI object and the map tile number. According to the exemplary embodiment, an SOI object may simply be configured to be mapped onto the map tile numbers that covers the SOI object.

The map tile converter 220 performs a process of mapping the obtained value of center point X, Y onto map tile number of a map.

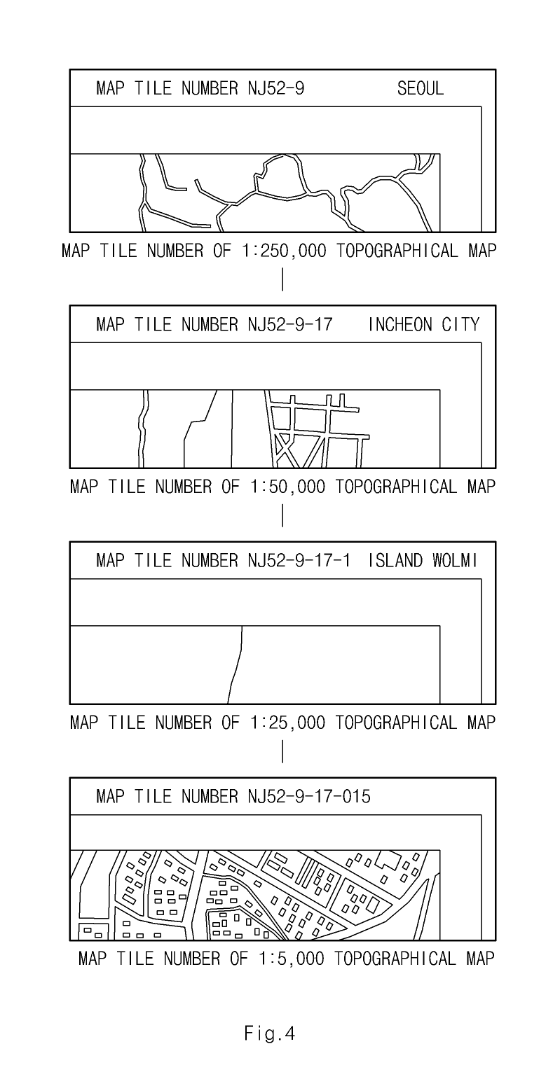

Here, the map tile number refers to identification numbers that are assigned in accordance with a level of a map. Hereinafter, brief information of the process will be described with reference to FIG. 4.

As shown in FIG. 4, according to a map level, the national capital region (Seoul), Incheon city, Wolmi Island are assigned TMS of NJ52-9 (the national capital region), NJ52-9-17 (Incheon city) and NJ52-9-17-015 (Island Wolmi), respectively. In other words, a process of assigning map tile numbers is performed in a hierarchical way according to each map level.

With respect to assigning map tile numbers, the first letter of N or S refers to the position of North and South on the earth, and then a latitude value is indicated with A, B, C, D to J, followed by a longitude value of, for example, 52 or 54 degrees. By this process, NJ52-9 is assigned to the national capital region, which is then classified into several sectors and classification numbers are given to each sector in a hierarchical way.

It is advantageous in that map tile numbers define a boundary for retrieval of geographic information, enabling a more rapid retrieval of geographic information.

For this advantage, the map tile number converter 220 performs a spatial operation to determine whether a center point of SOI object exists within a certain boundary of a map tile number, and mapping every SOI object included in accordance with the corresponding map tile number.

Here, according to a preferred embodiment of the present disclosure, SOI object having a certain boundary may be spread over a plurality of map tile numbers. In this case, SOI object may be configured to be mapped onto each corresponding map tile number.

The LBS indexer 230 performs a process of configuring as a package SOI object information mapped for each map tile number, and keyword index information mapped through the keyword indexer 100, which is then stored in an LBS inverted file indexing as a database.

The indexing system according to the present disclosure provides a rapid and effective retrieval of location information, as a map tile number is first extracted to obtain relevant SOI object information within the map tile number.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An indexing system of space of interest (SOI) defining at least a two-dimensional object, the system comprising:
a location data extractor configured calculate an index point for the space of interest;
a map tile number converter configured to map the index point to a tile that lies within a plurality of tiles; and
an indexer configured to index the space of interest based on the determined tile.

2. The indexing system of claim 1, wherein the SOI object is a combination of coordinates covering a certain boundary.

3. The indexing system of claim 1, wherein the location data extractor is further configured calculate an index point for the space of interest by:
creating a minimum bounding rectangle that encompasses the space of interest;
determining a center of the minimum bounding rectangle; and
returning the center of the minimum bounding rectangle as the index point for the space of interest.

4. The indexing system of claim 3, wherein:
the minimum bounding rectangle is defined by the minimum X coordinate (Xₘᵢₙ) of the space of interest, the minimum Y coordinate (Yₘᵢₙ) of the space of interest, the maximum X coordinate (Xₘₐₓ) of the space of interest, and the maximum Y coordinate (Yₘₐₓ) of the space of interest; and
the center of the minimum bounding rectangle is defined as
$$( {X}_{min} + \frac{{X}_{max} - {X}_{min}}{2} , {Y}_{min} + \frac{{Y}_{max} - {Y}_{min}}{2} ) .$$

5. The system of claim 3, wherein the location data extractor is further configured calculate an index point for the space of interest by modifying the index point to reflect one or more selected from the group consisting of: popularity of local tiles and user activity in local tiles.

6. The indexing system of SOI object of claim 1, wherein the LBS indexer receives keyword index information to perform mapping thereof in addition to a plurality of SOI objects mapped onto corresponding map tile numbers.

7. An indexing system of space of interest (SOI) object, the system comprising:
a location data extractor configured to identify an SOI object;
a map tile number converter configured to perform a spatial operation between the SOI object and a map tile number, and to perform mapping of the SOI object onto a corresponding map tile number; and
an LBS indexer configured to store a plurality of SOI objects mapped onto the corresponding map tile numbers in the form of an inverted file database.

8. The indexing system of SOI object of claim 7, wherein the SOI object is a combination of coordinates covering a certain boundary.

9. The indexing system of SOI object of claim 7, wherein the map tile converter performs mapping of the SOI object onto at least one or more of a plurality of map tile numbers, if the result of a spatial operation of the map tiles shows that the SOI objects cover a plurality of map tiles.

10. A method for indexing a space of interest (SOI) defining at least a two-dimensional structure, the method comprising:
calculating an index point for the space of interest;
determining which tile the index point lies within amongst of a plurality of tiles; and
indexing the space of interest based on the determined tile.

11. The method of claim 10, wherein the calculating step includes:
creating a minimum bounding rectangle that encompasses the space of interest;
determining a center of the minimum bounding rectangle; and
returning the center of the minimum bounding rectangle as the index point for the space of interest.

12. The method of claim 11, wherein:
the minimum bounding rectangle is defined by the minimum X coordinate (Xₘᵢₙ) of the space of interest, the minimum Y coordinate (Yₘᵢₙ) of the space of interest, the maximum X coordinate (Xₘₐₓ) of the space of interest, and the maximum Y coordinate (Yₘₐₓ) of the space of interest; and
the center of the minimum bounding rectangle is defined as
$$( {X}_{min} + \frac{{X}_{max} - {X}_{min}}{2} , {Y}_{min} + \frac{{Y}_{max} - {Y}_{min}}{2} ) .$$

13. The method of claim 10, wherein the location data extractor is further configured calculate an index point for the space of interest by modifying the index point to reflect one or more selected from the group consisting of: popularity of local tiles and user activity in local tiles.

14. A computer program product for causing a computer to perform a method for indexing a space of interest (SOI) defining at least a two-dimensional structure, the computer program product comprising computer-usable medium having control logic stored therein that, when executed by a processor, is operable to:
calculate an index point for the space of interest;
determine which tile the index point lies within amongst of a plurality of tiles; and
index the space of interest based on the determined tile.

15. A method of indexing a space of interest (SOI) object, the method comprising:
identifying an SOI object;
performing a spatial operation between the SOI object and a map tile number;
performing mapping of the SOI object onto a corresponding map tile number; and
storing a plurality of SOI objects mapped onto the corresponding map tile numbers in the form of an inverted file database.

16. A computer program product for causing a computer to perform a method of indexing a space of interest (SOI) object, the computer program product comprising computer-usable medium having control logic stored therein that, when executed by a processor, is operable to:
identify an SOI object;
perform a spatial operation between the SOI object and a map tile number;
perform mapping of the SOI object onto a corresponding map tile number; and
store a plurality of SOI objects mapped onto the corresponding map tile numbers in the form of an inverted file database.
